(19) United States
(12) Patent Application Publication
(10) Pub. No.: US 2026/0038394 A1
(43) Pub. Date: Feb. 5, 2026

(54) Sign for Shelving

(71) Applicant: Dana Industries Inc., Etobicoke (CA)

(72) Inventors: John RICCI, Kleinburg (CA); Frank BORGES, Toronto (CA)

(73) Assignee: Dana Industries Inc., Etobicoke (CA)

(21) Appl. No.: 19/012,268

(22) Filed: Jan. 7, 2025

Related U.S. Application Data
(63) Continuation-in-part of application No. 29/955,469, filed on Aug. 1, 2024.

(51) Int. Cl. G09F 7/18

(52) U.S. Cl. CPC G09F 7/18; G09F 2007/1821

(57) ABSTRACT

A sign adapted for installation on a vertical support of a shelving system comprises a sign portion and an anchor portion, wherein the anchor portion is adapted to be attached to the vertical support. The vertical support comprises a plurality of paired slots. The sign comprises a corresponding pair of tabs, comprising a first tab for insertion into one tab of the pair of slots and a second tab for insertion into the other of the pair of slots. The second tab being adapted to be locked to the other of the pair of slots.

### CROSS REFERENCE TO PRIOR APPLICATIONS

This application is a Continuation of U.S. application Ser. No. 29/955,469, filed Aug. 1, 2024, the entire contents of which are incorporated herein by reference.

### FIELD OF THE DESCRIPTION

The present description relates to signage systems. More particularly, the description relates to signage systems that are designed for use on vertical supports of commercial shelving systems and the like.

### BACKGROUND

In most commercial establishments where products are sold, the merchandise for sale is often placed on shelves so as to be displayed for potential customers. In addition to the products themselves, vendors often use signage to highlight their merchandise to customers and/or to provide such customers with details regarding products. In common “big box” stores, industrial shelving systems are used to store and/or display products. These shelving systems typically comprise a plurality of vertical support members to which are connected a plurality of horizontal support members, or rails. Shelving may then be placed on the horizontal members. The vertical support members are generally in the form of square or rectangular cylinders formed of heavy gauge metal and are provided with a plurality of slots along their lengths, generally on all sides. The slots are of a variety of known shapes such as keyhole, rectangular, etc. The slots are designed to receive pins or other such attachment means that are integral with or otherwise connected to the horizontal rails of the shelving system.

It is common to include signage on shelving systems so as to identify goods on a given shelf or to designate sections or areas of the commercial establishment to inform consumers. In many instances, the slots on the vertical supports facing into an aisle are often used to attach signage. This is sometimes done with ties etc. that are inserted into the slots and simply serve to fasten the sign to the support. Such attachments means, while simple, is generally difficult to undo and is not aesthetically pleasing. In other cases, specialized clips May be used, such as described in U.S. Pat. No. 6,698,124, to which a sign may be attached. Such devices add expense. Additionally, it is common for signs to extend perpendicularly from the shelving and protrude into the aisle. Since such signs are typically made of a plastic or paper-based material, they are susceptible to damage resulting from people and equipment moving through the aisle and colliding with the signs. This also results in the signs being dislodged from the securing devices such as discussed above.

A further version of a sign adapted for securing to a vertical support member is illustrated in US D916978. While this sign offers several advantages over those discussed above, it is still prone to being disengaged from the vertical support upon application of a physical force against the sign portion extending away from the vertical support.

There exists a need for a sign or signage system that addresses at least one of the deficiencies of known systems.

### SUMMARY OF THE DESCRIPTION

In a broad aspect, the present description provides a sign that is suitable for attachment to shelving systems incorporating vertical supports having a plurality of slots for engaging horizontal shelf support members. The sign includes an anchor portion that is adapted to be secured to one of the vertical supports, wherein the anchor portion includes pairs of tabs, comprising first and second tabs, wherein the pairs of tabs are adapted to be inserted into respective pairs of slots. The second tabs are further modified to lockingly be received in the slots.

Thus, in one aspect, there is provided a sign for attachment to a shelving system, the shelving system comprising a vertical support having a plurality of slots therein arranged in pairs, each of the slots having a slot height, the sign being formed of a flexible material and comprising:
a sign portion, extending generally along a first plane, for displaying information and a generally planar anchor portion, extending along a second plane, and being adapted to be attached to the vertical support, the anchor portion comprising:
at least one first tab adapted to be inserted into one of the pair of slots; and,
at least one second tab adapted to be inserted into the other of the pair of slots;
the at least one first tab having a height, as measured along the first plane, that is the same or less than the slot height;
the at least one second tab having a generally arrowhead shape comprising a tab body and oppositely directed barbs extending along the second plane, each of the barbs having barb tips, wherein the distance between the barb tips, as measured along the second plane, is greater than the slot height.

### BRIEF DESCRIPTION OF THE FIGURES

The features of certain embodiments will become more apparent in the following detailed description in which reference is made to the appended figures wherein:

FIG. 1 is a front perspective view of a known shelving system.

FIG. 2 is a front right perspective view of a sign according to one embodiment as attached to a vertical support member of a shelving system.

FIG. 3 is rear left elevation view of the sign of FIG. 2.

FIG. 4 is a rear elevation view of the sign of FIG. 2.

FIG. 5 is an enlarged view of the sign of FIG. 2 showing the tabs of the anchor portion thereof.

FIG. 6 is a plan view of a blank for a sign according to another embodiment.

FIG. 7 is a front right perspective view of a sign according to another embodiment as attached to a vertical support member of a shelving system.

### DETAILED DESCRIPTION

As used herein, the term “sign” or “signage system” will be understood to mean one or more signs or flags, etc., as known to persons skilled in the art. Such signs, as discussed above, generally extend perpendicularly into an aisle or other such passageway as provided in commercial establishments. 2

The terms “horizontal” and “vertical” may be used in the present description. These terms will be understood as being merely descriptive in nature and are not intended to imply any particular angular arrangement.

The terms “comprise”, “comprises”, “comprised” or “comprising” may be used in the present description. As used herein (including the specification and/or the claims), and unless stated otherwise, these terms are to be interpreted as open-ended terms and as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

The term “and/or” can mean “and” or “or”.

Unless stated otherwise herein, the articles “a” and “the”, when used to identify an element, are not intended to constitute a limitation of just one and will, instead, be understood to mean “at least one” or “one or more”.

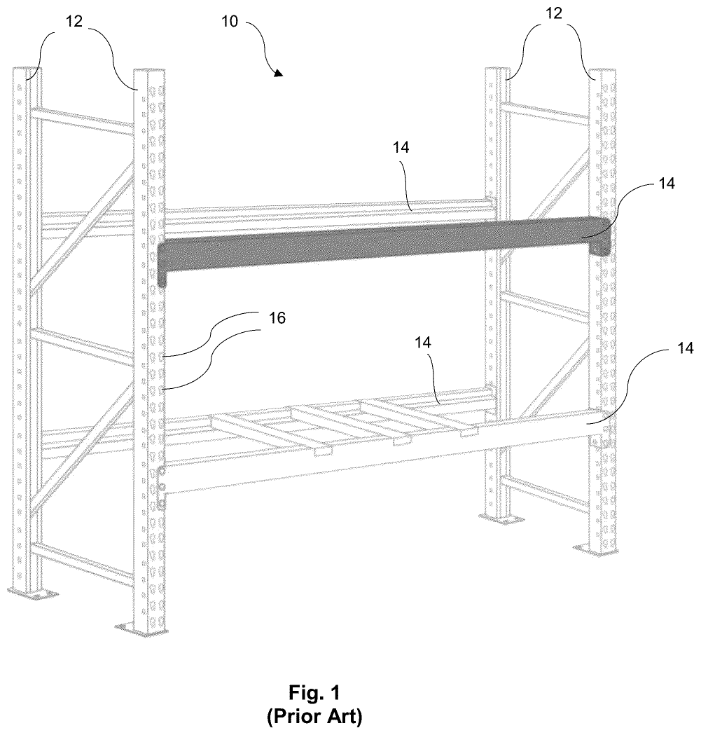

FIG. 1 illustrates a shelving system as known in the art. As mentioned above, the shelving system 10 comprises a plurality of generally vertical support members 12 to which are attached a plurality of horizontal supports or rails 14. Shelving panels may then be placed over the horizontal rails, onto which goods may be placed. It will be understood that the shelving panels may be formed or be integral with the horizontal rails.

As also discussed above, the vertical supports of the known shelving systems are provided with a plurality of slots, as shown at 16. The slots 16 are adapted to receive connecting members that are provided on the rails. In one example, the opposite ends of the rails may be provided with brackets, as shown in FIG. 1, having connecting members, such as pins, that are inserted into the slots. As also shown in FIG. 1, it is common for the slots 16 to have an inverted teardrop shape. This is common owing to the connecting members comprising pins with enlarged heads. Once the head is inserted into the top of the slot 16 the rail is lowered thus engaging the pin within the slot. The head then prevents separation of the rail and vertical support. Other shapes of slots are also well known, including “V” shapes, and simple rectangular shapes. The present description is not limited to any particular slot shape.

Generally, and as shown in FIG. 1, the vertical members are provided with pairs of slots over a majority of their lengths. The pairing of the slots allows adjacent rails to be positioned at the same vertical height, as would be understood. Providing a large number of slots, i.e., over the majority of the length of the vertical member, allows the rails to be at any height and also allows for multiple rails to be included (i.e., to provide multiple shelves). Consequently, many of the slots 16, as shown in FIG. 1, may be unoccupied and are often used to attach signage, as discussed above.

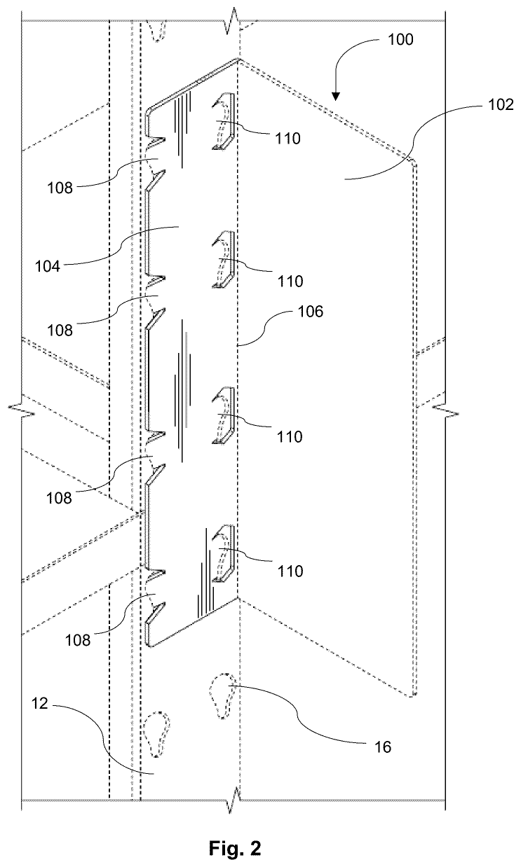

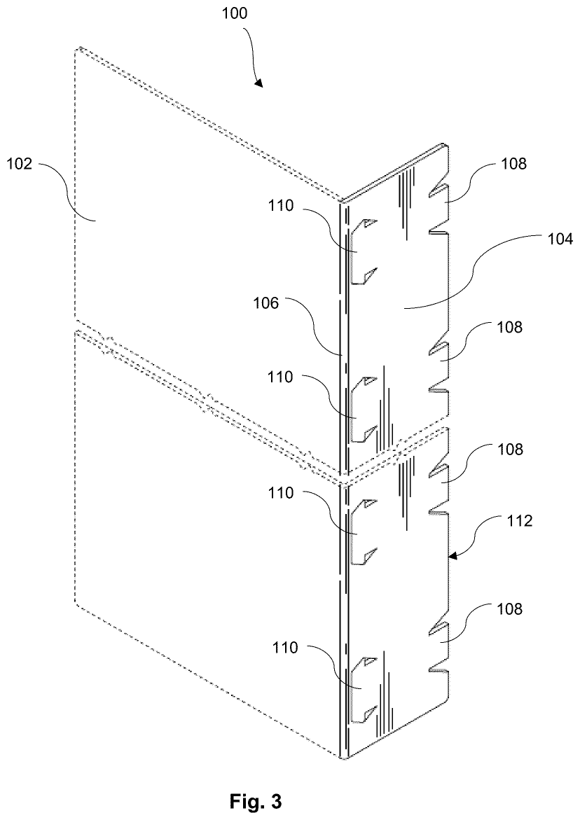

FIGS. 2 and 3 illustrate a sign according to one embodiment of the present description FIG. 2 illustrates one embodiment of the sign once secured to a vertical support 12 of a shelving system (such as shown in FIG. 1) and FIG. 3 illustrates the sign of FIG. 2 in isolation. As shown, the sign comprises a sign or flag portion 102 and a base or anchor portion 104. As will be understood from the present description, the term “anchor portion” is used herein as such portion is what is attached, or anchored, to the vertical support 12.

In one embodiment, both the flag portion 102 and anchor portion 104 are generally planar but are arranged in an angled manner, wherein the flag portion 102 lies on a first plane and the anchor portion 104 lies on a second plane. In the preferred embodiment, the first plane is angled with respect to the second plane, and more preferably the first plane is generally perpendicular to the second plane, whereby, as shown, the flag portion 102 extends generally perpendicularly to the anchor portion 104. For this purpose, a crease 106 is formed in the sign 100, which also serves to delineate the flag and base portions. As will be understood, although the sign portion 102 is defined as being planar, it will be understood that this characterization is intended to indicate a general shape. That is, the sign portion 102, may have, for example, a 3D shape that extends away from the anchor portion. The present description is not limited to any particular shape or orientation of the sign portion.

In a preferred embodiment, the sign 100 is formed from a flat sheet or blank of a thermoplastic material, that is, a material that becomes plastic upon application of heat but is then returned to its hardened state upon cooling. In the present description, the blank of thermoplastic material is capable of being bent to the shape as shown in the figures (i.e., with the sign portion being angled with respect to the anchor portion) by applying heat along the line where the crease 106 is to be formed, and subsequently deforming or bending the sheet along such line into the desired shape of the sign.

As also shown in FIGS. 2 and 3, the base portion 104 of the sign 100 is provided with a plurality of tabs, namely, first, or positioning tab 108 and second, or locking tab 110, that are adapted to be inserted into adjacent pairs of the slots 16 of the vertical support 12 as described above. For this reason, the tabs 108 and 110 are preferably also arranged in pairs, as shown in FIGS. 2 and 3, to facilitate engagement with the pairs of slots 16. Accordingly, the base portion 104 is adapted to be placed against the body of the vertical support, as shown in FIG. 2. The first tabs 108 are provided along a first edge 112 of the base portion 104, whereas the second tabs 110 are preferably positioned along a second edge 114, comprising the crease 106.

The tabs 108 and 110 are preferably formed by die cutting a sign blank. As mentioned above, the sign itself is preferable formed of a flexible thermoplastic sheet. Accordingly, the tabs 108 and 110 are flexible and elastic, whereby, when the sign is being installed, the tabs can be manually pressed into the slots 16 of the vertical support 12.

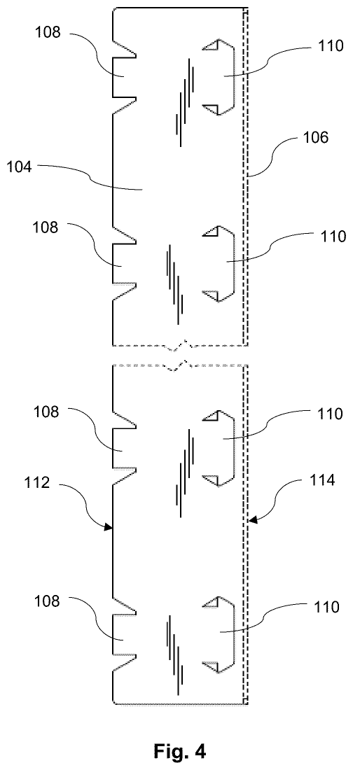

As shown in FIGS. 3 to 5, a unique feature of the sign 100 comprises the shape of tabs and, more specifically, the shape of the second tabs 110. In particular, and as shown, first or positioning tabs 108 are provided with a generally rectangular or square shape and are designed to easily be inserted into a first of the pair of slots 16. In this regard, the height 116 of each of the first tabs 108, as measured along the first edge 112, is preferably the same or shorter than the height of the slots 16. As would be understood, this structure facilitates the insertion of the first tabs 108 into respective slots 16. Doing so over the length of the sign 100 thus allows the sign 100 to be easily positioned at a desired location on the vertical support 12.

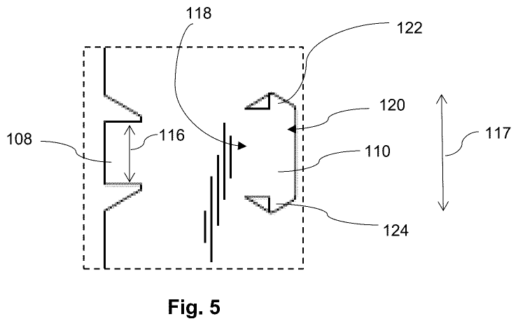

In contrast, the second or locking tabs 110 are provided with an arrowhead shape, comprising a base 118 that is integral with the anchor portion 104 and a tip 120. The tip 120 comprises two oppositely oriented barbs 122 and 124 each having respective barb tips. As seen, for example in FIG. 5, the maximum height 117 of the tip 120, as measured from the tips of each of the barbs 122 and 124, is greater than the height 116 of the first tab 108. Preferably, the maximum height 117 of the locking tab 110 is greater than the height of a respective slot 16. In this way, insertion of the second, or locking tab into the slot 16 requires temporary deformation of the barbs 122 and 124 by application of a manual force, so as to allow the locking tab 110 to be entered into the opening of the slot 16. Once the deformation force is released, and owing to the resilient and elastic nature of the material from which the sign 100 is made, the locking tab 110 returns to its original form as shown in FIG. 5. Thereupon the tip 120 of the locking tab 110 is locked into the slot 16. The same insertion step is then followed for the other locking tabs 110 of the sign 100. It will be understood that the present description is not limited to any particular number of first and second tabs and that the number of tabs may vary based on the length of the sign.

Once the locking tabs 110 are inserted into the respective slots 16, using the steps described above, it will be understood that the sign is secured in place on the vertical support 12.

It is noted that the locking tabs 110 are preferably provided on the second edge 114 of the anchor portion 104 of the sign 100. It will be understood that such arrangement is preferred given that the second edge 114 will be subject to greater stresses than the first edge 112 in view the sign portion 102 being formed along the second edge 114. For example, since the sign portion 102 extends into the aisle when the sign is in use, such portion will be subjected to impact from persons or equipment, etc. Accordingly, providing the anchor tabs 110 along the second edge 114 mitigates against dislodging of the sign from the vertical support 12.

As mentioned above, the sign 100 is preferably formed from a single, flat sheet of thermoplastic material. As an initial step the tabs 108 and 110 are formed on the blank by any suitable process. This may involve, for example, a stamping or cutting operation. The description is not limited to any particular means of forming the tabs. Therefore, and as mentioned above, heat is applied to the region where the crease 106 is to be formed. The blank is heated to a point where permanent deformation of the material is made possible. At that point, the blank is bent or folded at the crease in order to establish the desired angle between the sign portion 102 and the anchor portion 104. In a preferred embodiment, and as discussed above, such angle is roughly 90 degrees, which allows the sign portion 102 to extend generally perpendicularly away from the anchor portion 104 when the sign is installed. 2

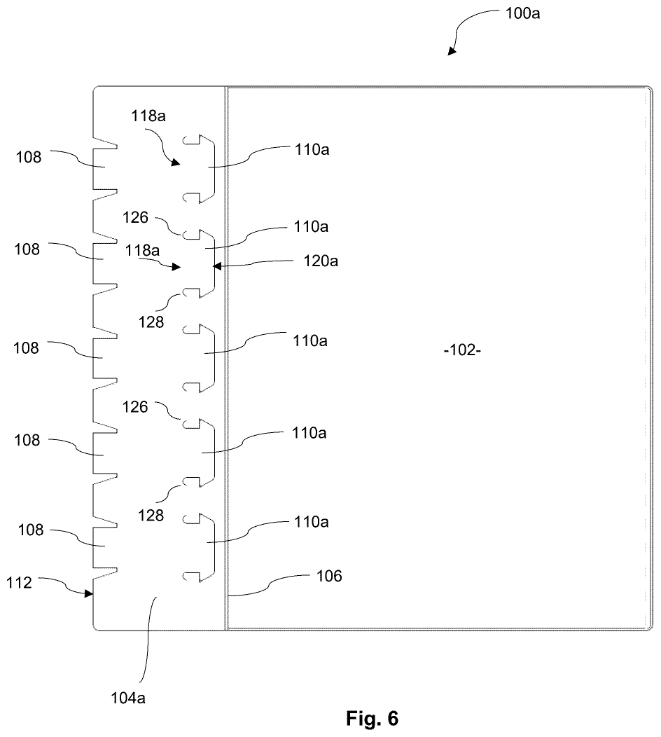

FIG. 6 illustrates a blank for a sign according to a further embodiment. Elements shown in FIG. 6 that are the same as those described above are identified with the same reference numerals. Elements that are similar but varied are identified with the same reference numeral but with the letter “a” added for clarity.

As shown, the blank of FIG. 6 has a variation in the locking tabs 110a, wherein the base 118a of the tab is provided with a curved cut on each side thereof. Specifically, as seen in FIG. 6, each of the anchor tabs 110a is formed with curved cuts 126 and 128. The curved cuts 126, 128 are formed at the time of forming the tabs 108 and 110 and, as shown extend away from the base 118a and are preferably curved in a direction towards the tip 120a.

As would be understood by persons skilled in the art, the curved cuts 126 and 128 are provided to facilitate flexure of the anchor tab 110a with respect to the anchor portion 104a. In particular, the curved cuts allow repeated flexure of the anchor tabs 110a, as would occur over a number of installations and removals from a vertical support, while limiting any permanent damage to the corners that join the base 118a to the body of the anchor portion 104a. Thus, the cuts 126 and 128 are preferred for increasing the usage life of the sign 100a. Although the cuts 126 and 128 are described in terms of a separate embodiment, it will be understood that that such features may be included in any sign described herein.

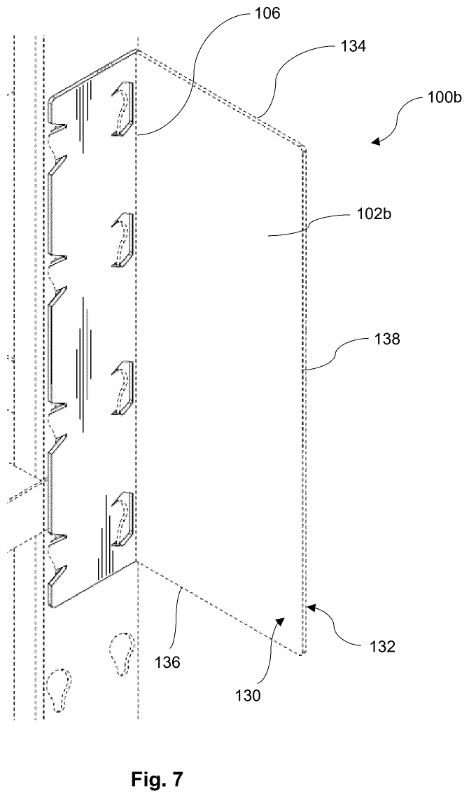

In the above discussion, an embodiment has been described wherein the sign 100 or 100a is formed from a flat sheet of material, in particular a thermoplastic material. Accordingly, any part of the sign 100, that is the sign portion 102 or the anchor portion 104, may contain printing, colour, and/or artwork as needed or desired for the particular area where the sign is used. In some cases, the information displayed on a given sign may need to be changed at certain times. This may occur, for example, where the goods on a particular shelf or area are changed. In such cases, the existing pre-printed sign would need to be removed and replaced with another pre-printed sign. As mentioned above, such repeated installation and removal May place repeated mechanical stresses on the tabs, in particular the anchor tabs, of the present description. To address this issue, another embodiment of the description is provided, as illustrated in FIG. 7, wherein elements that are similar but varied are identified with the same reference numerals as above but with the letter “b” added for clarity. As shown in FIG. 7, the sign 100b has a sign portion 102b that comprises two sheets, 130 and 132, that are placed against each other. The sheets 130, 132 are sealed together along the crease 106 and along the top edge 134 and bottom edge 136, of the sign portion 102b. A free edge 138 of the sign portion 102b, opposite to the crease 106, is left unsealed. In this way, promotional or informational material, provided, for example, on a sheet of paper, plastic, or cardboard, etc., may be inserted through the free edge 138 and positioned between the sheets 130 and 132. It will be understood that at least one of sheets 130 and 132 will be transparent or translucent so as to allow the desired information placed therebetween to be viewed. It will also be understood that with this embodiment, the material to be displayed may be changed as needed without detaching the sign 100b from the vertical support.

In the above description, various embodiments have been described. As will be understood by persons skilled in the art, the described embodiments are not mutually exclusive and, therefore, one or more embodiments may be combined together as needed or desired.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all references in the present description herein are incorporated herein by reference in their entirety.

We claim:

1. A sign for attachment to a shelving system, the shelving system comprising a vertical support having a plurality of slots therein arranged in pairs, each of the slots having a slot height, the sign being formed of a flexible material and comprising:
a sign portion, extending generally along a first plane, for displaying information and a generally planar anchor portion, extending along a second plane, and being adapted to be attached to the vertical support, the anchor portion comprising:
at least one first tab adapted to be inserted into one of the pair of slots; and,
at least one second tab adapted to be inserted into the other of the pair of slots;
the at least one first tab having a height, as measured along the first plane, that is the same or less than the slot height;
the at least one second tab having a generally arrowhead shape comprising a tab body and oppositely directed barbs extending along the second plane, each of the barbs having barb tips, wherein the distance between the barb tips, as measured along the second plane, is greater than the slot height.

2. The sign of claim 1, wherein each of the first and second tabs include a respective base portion pivotally attached to the anchor portion, whereby the first and second tabs are elastically moveable with respect to the second plane.

3. The sign of claim 2, further comprising curved cuts on opposite sides of the base portion of the at least one second tab at a region of the anchor portion, whereby flexion of the base portion of the second tab with respect to the anchor portion is facilitated.

4. The sign of claim 1, wherein the at least one second tab extends in a direction away from the sign portion.

5. The sign of claim 1, wherein the at least one first tab extend in a direction towards the sign portion.

6. The sign of claim 1, wherein the first plane is angled with respect to the second plane and wherein a crease is formed between the sign portion and the anchor portion.

7. The sign of claim 6, wherein the first plane is angled at about 90 degrees with respect to the second plane.

8. The sign of claim 1, wherein the sign portion is generally planar.

9. The sign of claim 1, wherein the sign portion comprises two facing planar sheets forming a pocket there-between.

10. A method of forming the sign of claim 1 comprising:
providing a planar blank of a flexible thermoplastic material;
forming the first and second tabs in the blank;
heating a dividing line between the sign portion and the anchor portion;
bending the blank along the dividing line to form a crease; and,
cooling the blank.
